(19) United States
(12) Patent Application Publication
(10) Pub. No.: US 2004/0140304 A1
(43) Pub. Date: Jul. 22, 2004

(54) Baby bottle chiller/warmer and method of use

(76) Inventor: Kurt Philip Leyendecker, Highlands Ranch, CO (US)

Correspondence Address: KURT LEYENDECKER, 9241 S LARK SPARROW DR., HIGHLANDS RANCH, CO, 80126, US

(21) Appl. No.: 10/348,792

(22) Filed: Jan. 22, 2003

(51) Int. Cl. F25B 21/02; F24C 7/10; F27D 11/00; F17C 13/00; F25B 21/00; H05B 3/06

(52) U.S. Cl. 219/386; 219/521; 62/3.3; 62/457.9

(57) ABSTRACT

A device for chilling and warming a baby bottle in a single chamber is described including a method of operating the device. The device typically utilizes a thermoelectric module to chill the chamber. The thermoelectric module can also be used to warm the chamber or a separate resistive heater may be provided. A clock circuit is utilized in certain embodiments that can be set to an activation or target time to automatically cause the device to switch from a chilling mode to a warming mode at the activation time.

### FIELD OF THE INVENTION

The invention relates generally to an apparatus for chilling and warming a container of liquid, and more specifically a baby bottle chilling and warming device that utilizes a thermoelectric device for cooling and/or warming a liquid contained in a baby bottle.

### BACKGROUND OF THE INVENTION

Doctors and other health professionals recommend that bottles of breast milk and/or baby formula be warmed prior to feeding to a baby to aid in digestion.

Historically, baby bottles were warmed by heating them in a pot of warm water on a stovetop. This process is time consuming since the stovetop's heating element, the pot, and the water in the pot in addition to the milk or formula in the baby's bottle must be heated. Further, since it is difficult to control the resulting temperature of the baby's milk or formula to a high degree of precision using this method, a caregiver may need to allow the bottle to cool before feeding the baby.

More recently, microwaves have been used to heat up baby's bottles. The heat-up time is typically significantly reduced when compared to the stovetop method. However, microwaving can have deleterious effects on the breast milk and/or formula by breaking down essential nutrients in the liquid and thereby reducing the nutritional value of the milk or formula to the baby. Additionally, like the stovetop method, precise control of the resulting temperature of the milk or formula is difficult to achieve.

To counter both the slow warming times of the stove top approach, the uncertain resulting liquid temperatures and the deleterious effects of microwaving, baby bottle warmers have been introduced to the market. A typical baby bottle warmer comprises a heated chamber in which a baby bottle containing a cold liquid is placed. A heating element is provided at the base of the chamber that heats up water that is added to the chamber. In certain models, only a small amount of water is required as the water is heated to make steam that surrounds the bottle and heats the bottle. Since at or near sea level water does not vaporize into steam until a temperature of 100 degrees C., a bottle can easily be overheated if left in the warmer too long. Further, if the bottle is not carefully removed from the warmer, the caregiver could be scalded. Finally, there is a danger that if the warmer is accidentally left on, all the water could be vaporized and the unit could overheat, potentially creating a fire hazard In other models of bottle warmers substantially more water is utilized to at least partially immerse the bottle. The water is warmed to an elevated temperature and is used as the medium through which heat energy is transferred to the bottle and its contents. Since lower temperatures are utilized when compared to the steam generating warmers there is less likelihood of overheating the bottle or of scalding of a caregiver. Further, since the amount of water utilized is greater and the temperatures are lower, there is less chance of the water drying up and causing the warmer to become a fire hazard.

Depending on the complexity of a bottle warmer, it may include one or more of a simple on/off switch, a timer and a temperature-measuring device to either control the heating element or assist a user in the operation of the warmer. In more advanced bottle warmers an audible and/or visual signal alerting a user when the bottle has probably reached the proper temperature for a baby's consumption may be provided. It is appreciated that none of the warmers on the market directly measure the temperature of the bottle or its contents; rather, they typically utilize preset heating cycles that will under typically conditions provide a bottle with contents at or close to a specific temperature. Unfortunately, these cycles are not very reliable and over heated milk or formula can result.

Newborn babies typically require feeding every 2-4 hours for the first several months of their lives. Unfortunately, this necessitates a caregiver getting up once or twice in the middle of the night to feed the baby. Typically, a caregiver gets up when the baby cries to indicate his/her hunger, goes to the refrigerator, removes a bottle of milk or formula, places the bottle in the warming device, waits for the bottle to warm, and finally, feeds the baby. If the caregiver and the baby sleep on the second floor of a two-story house, at least one trip up and down stairs is required. The entire process of preparing to feed the baby may take upwards of 10-15 minutes. Additionally, another 20-30 minutes is often required to actually feed the baby. To a sleep-deprived caregiver, the loss of even a few minutes of sleep can be significant.

In general, newborn babies respond well to routine including regular feeding schedules. Once a feeding schedule is established, a baby will typically wake and begin crying within 20 minutes of a specific feeding time. Despite the general adherence to a feeding schedule, at times a baby will oversleep and miss his feeding time by a significant amount, causing disruption in the feeding schedule for a period thereafter until a new schedule can be established. Additionally, concerning nighttime feedings, the baby might awaken and start crying at a time very close to his/her feeding time, but because the caregiver is asleep, the caregiver may not awaken immediately. By the time the caregiver is up and the baby's bottle is prepared, it can be well over 30 minutes past the preferred scheduled feeding time, thereby also causing disruption in the feeding schedule. The lack of a set feeding schedule can be very stressful on a caregiver, whose ability to carry on other activities is compromised by the uncertain feeding times of the baby. Further, the break from routine may cause the baby additional stress possibly leading to over stimulation and increased periods of crying.

### SUMMARY OF THE INVENTION

A device for chilling and warming a baby bottle and a method for using the device are described In one preferred embodiment, the device comprises a chamber adapted for at least partially receiving a baby bottle in it, a thermoelectric module (TEC) and a power supply. The TEC has a first face and a second face with the first face being thermally coupled with the chamber. An electrical circuit electrically couples the DC power supply with the TEC. The electrical circuit includes one or more switching mechanisms for reversing the direction of current flow through the TEC. The TEC cools the chamber when current flows in a first direction and warms the chamber when the current flows in a second direction. The electrical circuit also includes a clock circuit. The clock circuit is adapted to perform a first function. The first function permits a user to select one of (a) an activation time for switching the device from a chilling mode to a warming mode and (b) a target time for ending a heat-up phase of the warming mode. The activation of the first function at a time relative to one of the activation time and target time causes the one or more switching mechanisms to reverse the direction of current flow through the TEC.

In another preferred embodiment, the device comprises a chamber adapted for at least partially receiving a baby bottle in it, a thermoelectric module, a DC power supply and an electrical circuit. The thermoelectric module has a first face and a second face wherein the first face is thermally coupled with the chamber. The electrical circuit electrically couples the DC power supply with the thermoelectric module, and includes (i) a first portion adapted to provide a flow of DC voltage in a first direction through the thermoelectric module to warm the chamber, (ii) a second portion adapted to provide a flow of DC voltage in a second direction through the thermoelectric module to cool the chamber and (iii) one or more switching mechanisms coupling the first and second portions to the DC power supply. The first portion of the electrical circuit includes a first thermal switch that is thermally coupled with the first face and adapted to stop the flow of DC voltage when a temperature of the first thermal switch exceeds a first temperature value. The second portion of the electrical circuit includes a second thermal switch that is thermally coupled with the second face and adapted to stop the flow of DC voltage when a temperature of the second thermal switch exceeds a second temperature value.

A preferred method of operating the device includes placing a baby bottle containing a fluid at least partially into a single chamber of a device for chilling and warming the baby bottle. Next, the baby bottle is chilled while at least partially contained in the single chamber. Finally, the baby bottle is warmed without removing it from the chamber.

### BRIEF DESCRIPTION OF THE DRAWINGS

The following figures are provided by way of example and not limitation. Element numbers that share the last two digits generally represent similar elements in each of the figures in which they appear.

FIG. 1 is a stylized view of a typical thermoelectric module.

FIG. 2 is a performance chart for a thermoelectric module.

FIG. 3 is an isometric front view of a first embodiment baby bottle chilling and warming device.

FIG. 4 is cross sectional view of a first variation of the first embodiment device taken along line 3-3 of FIG. 2.

FIG. 5 is a cross sectional view of a second variation of the first embodiment device.

FIG. 6 is a schematical representation of the electrical circuitry utilized in the first embodiment.

FIG. 7 is an isometric front view of a second embodiment chilling and warming device.

FIG. 8 is a schematical representation of the electrical circuitry utilized in the second embodiment device.

FIG. 9 is a block diagram illustrating the circuitry of a third embodiment chilling and warming device.

FIG. 10 is a schematical representation of the electrical circuitry utilized in the fourth embodiment device.

FIG. 11 is a cross sectional view of one configuration of the four embodiment device.

FIG. 12 is a schematical representation of the electrical circuitry utilized in the fifth embodiment.

FIG. 13 is a flow diagram illustrating a preferred embodiment for using the chilling and warming device.

FIG. 14 is a chart indicating the temperatures of the chilling and warming device's chamber during hypothetical cooling and warming cycles.

### DETAILED DESCRIPTION

Overview

A device for both cooling (chilling) and warming a baby bottle filled with formula, breast milk or other fluids and a method for using the device are described. Depending on the various embodiments described herein and variations thereof, water added to a heating chamber may or may not be utilized as a heat transfer medium. Preferred embodiments of the baby bottle chilling and warming device utilize a thermoelectric module to selectively chill and warm a bottle without removing the bottle from a provided chamber. Accordingly, a caregiver can place a bottle in the chamber and place the bottle in the chill mode before retiring for the evening. When it is time to feed the baby, the apparatus can be switched into the warming mode to warm the milk or formula contained in the bottle to a selected or predetermined elevated temperature. Presumably, the caregiver can prepare the baby for feeding (i.e. getting the baby out of its crib and changing the baby's diaper) while the formula/milk is warming.

In another embodiment, a clock circuit is provided that can be set to automatically begin warming a chilled bottle so that the bottle will be properly warmed at or close to a preselected time, such as the expected feeding time of the baby. An audible and/or visual alarm may also be provided to alert the caregiver that the preselected time has arrived and/or the bottle has been warmed. Additionally, variations of the clock circuit can provide f)r input concerning the amount of milk or formula in the bottle to be warmed such that the length of the warming cycle can be varied accordingly.

In yet another embodiment, an electronic controller is provided to control the warming and chilling modes of the chilling and warming device, as well as monitor the temperatures of each side of the thermoelectric module. The controller also includes a clock circuit and can be set to warm the baby bottle for use at a preselected time in a manner similar to that described above. Further, in variations of the controller, the caregiver can adjust the chilled and warmed temperatures to help ensure the bottle is refrigerated at a sufficiently low temperature and the bottle is warmed to an optimum temperature for the baby.

The embodiments of the chiller/warmer apparatus illustrated in the accompanying Figures and described herein are merely exemplary and are not meant to limit the full scope of the invention. It is to be appreciated that numerous variations to the invention have been contemplated as would be obvious to one of ordinary skill in the art with the benefit of this disclosure. Further, with advances in technology during the life of this patent, variations of the invention incorporating applicable technological advancements may be developed. All variations to the invention that read upon the appended claim language are intended and contemplated to be within the scope of the invention whether based on current technology or technology that has yet to be developed.

Thermoelectric Modules

Thermoelectric modules (TECs) are utilized in three of the ,referred embodiments described herein to provide for both the warming and chilling of a baby bottle. In the two other preferred embodiments described herein, TECs are utilized only to chill the baby bottle. Thermoelectric modules are well known in the art and may be purchased from a variety of sources including but not limited to Thermonamic Electronics (Xiamen) Co., Ltd. of China. TECs act to transfer heat from a one surface to another surface when DC voltage is passed through the module in a first direction thereby effectively cooling the one surface and warming the other surface. Depending on the particular design and construction of a TEC, temperature differentials of up to 70 degrees Celsius can be obtained between the two typically opposing surfaces. By reversing the flow direction of the DC voltage, however, the warmed surface becomes the chilled surface and the chilled surface becomes the warmed surface. The reversibility of the thermoelectric module allows a surface of the module that is thermally coupled to the chamber of the chilling and warming device and/or the baby bottle contained therein to be selectively warmed or chilled.

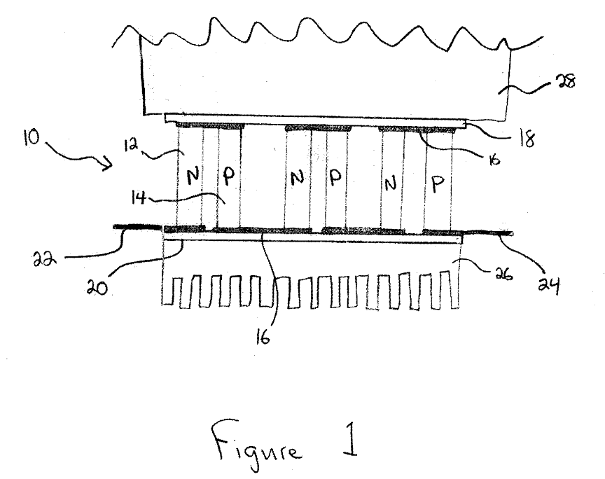

A schematic representing a typical commercially available FEC is illustrated in FIG. 1. The TEC 10 generally comprises pairs of N-type and P-type semiconductor elements 12 and 14. Usually, Bi2Te3 semiconductor material is utilized to fabricate the elements, although the use of other materials is possible. An N-type semiconductive material is that which has been doped to have an excess of electrons and a P-type semiconductive material is doped to have a deficiency of electrons. The pairs are connected electrically in series with conductive metallic interconnects 16, such that an applied DC voltage passes alternately through a P-type element 16 and a N-type element 14. Typically, the semiconductive elements are sandwiched between two thin ceramic substrates 18 and 20, although substrates made of other insulating materials or non-insulating materials with an appropriate insulating coating can also be used. The substrates provide structural integrity to the TEC, electrically insulate the elements, and provide surfaces for mounting to an object 28 that is to be heated or cooled. Finally, leads 22 and 24 are provided for attaching the TEC to a DC power source.

The science and operational characteristics of TECs are well known in the art and are briefly described herein to provide context for the baby bottle chilling and warming device and its associated components. By passing a DC voltage through the N and P element pairs, electrical energy is converted into a temperature gradient (this is commonly known as the “Peltier Effect”). Essentially, as current flows through the semiconductive elements, it attempts to establish an electron equilibrium in the elements: the P-type element functions as a hot junction needing to be cooled and the N-type element functions as a cold junction needing to be heated even though both N-type and P-type elements are at essentially the same temperature initially. Operationally, heat is pumped out of the P-type element in the direction of the current flow. Accordingly, when the current is flowing in a first direction, heat will be pumped from the upper substrate 18 and the object 28 attached to it to the lower substrate 20 and out the heat sink 26. Conversely, if the direction of current flow is reversed, the heat will be pumped from the heat sink into the object. The surface of the ceramic substrate 18 or 20 to which heat is being pumped is typically referred to as the hot side and the surface of the opposing substrate from which the heat is being removed is typically referred to as the cold side.

There are four standard values typically specified for commercially available TECs: (1) the maximum heat pumping capacity of the module in watts (Qmax); (2) the maximum achievable temperature difference between the hot and cold sides of the module (Delta Tmax); (3) the maximum optimal input current in amps (Imax); and (4) the maximum optimal input voltage when the current input is at its optimal maximum (Vmax). When operating at the Imax and Vmax parameters, Delta Tmax is achieved only when there is no heat load (i.e. Q=0). Conversely, Qmax is achieved when operating at Imax and Vmax only when there is no net heating or cooling (DeltaT=0). Since the baby bottle and the fluid contained therein, not to mention the interior portion of the chamber of the chilling and warming device, have significant thermal mass and since it is desirable to maintain a temperature difference between the warmed or cooled baby bottle and ambient temperature to which the one side of the TEC is exposed, the actual temperature difference between opposing surfaces of the TEC and the heat pumping capacity of the TEC will be less than DeltaTmax and Qmax respectively. For instance, the actual Q value for a TEC in operation is dependent on a number of factors including: (i) the hot side temperature (Th); (ii) the temperature difference (DeltaT) between the hot side and the cold side; (iii) the current (I) and the voltage (V) applied to the TEC. It is to be appreciated that V and I are related by the well-known relationship, V=IR, where R is the resistance of the TEC. Typical commercially available single stage TECs suitable for use in a baby bottle chilling and warming device have DeltaTmax's of around 65-70 degrees Celsius and Qmax's up to about 200 watts.

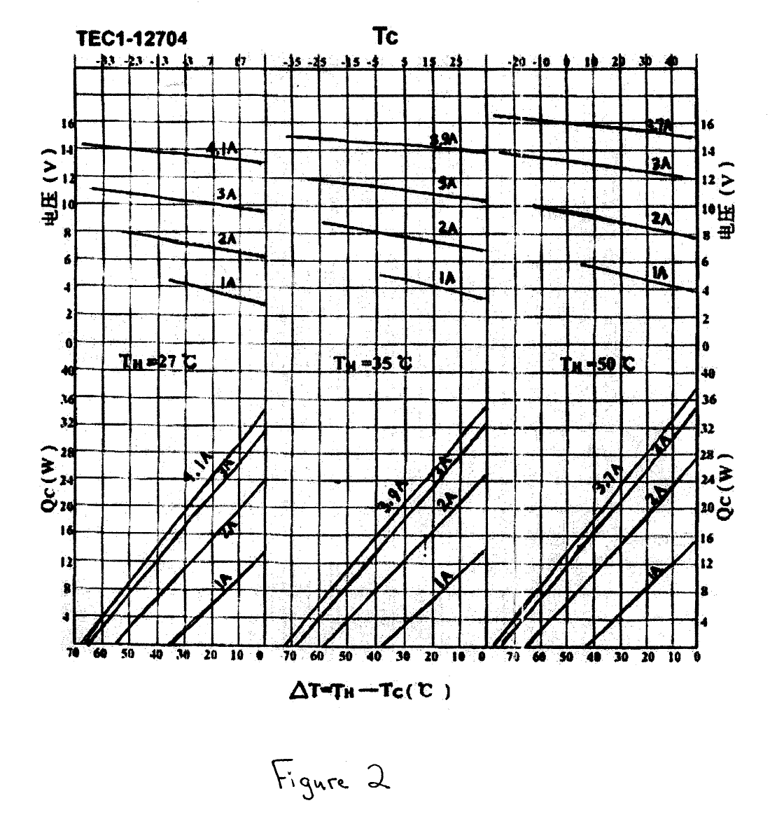

FIG. 2 illustrates a typical performance chart that can be utilized to help determine the actual heat pumping capacity (Q) of a TEC based on variations of the factors provided above. This particular chart was provided by Thermonamic Electronics (Xiamen) Co., Ltd concerning their TEC1-12704 thermoelectric module, which has a Qmax of 33.4 watts and a DeltaTmax of 69 degrees Celsius. Other TEC manufacturers also provide similar charts for their TECs.

A low temperature of about 5 degrees Celsius is generally desired within the bottle chamber of the baby bottle chilling and warming device to sufficiently refrigerate the baby bottle's contents. The ambient indoor temperature is typically about 20 degrees Celsius. It is generally not practical and cost effective to maintain the hot side of the TEC at the ambient temperature. Very large heat sinks and very powerful cooling fans or more complex heat dissipation devices, such as liquid chillers or heat pipes, would be required that would be disproportionately expensive compared to the TEC. Accordingly, heat sinks and fans are typically utilized that maintain the hot side at a Th of around 5-20 Celsius higher than ambient resulting in a typical Th of about 25-40 degrees C. A DeltaT of between the hot side and the cold side will typically vary from about 15 degrees up to 30 degrees during a cooling operation (assuming the temperature of the hot side is 35 degrees Celsius). Assuming the TEC, whose performance chart is depicted in FIG. 2, is used with a 12-volt power supply, the TEC will draw about 3.2 amps when the DeltaT is 30 degrees Celsius. Accordingly, as indicated in FIG. 2, the minimum actual heat pumping capacity (Q) of the TEC under these specified conditions would be about 18 watts.

When the polarity of the DC current provided to the TEC is reversed, the side of the TEC in thermal contact with the chamber and/or baby bottle becomes the hot side and the side of the TEC in contact with the heat sink becomes the cold side. Ideally, the baby bottle should be heated to a temperature close to a baby's body temperature or slightly higher (37-40 degrees C.). Since no 37-degree Th chart is provided in FIG. 2, the 35 degree C. chart is utilized for purposes of this example. In operation, the cold side will likely obtain and stabilize at a temperature below ambient by about 10-15 degrees C. or around 5 degrees C. The associated DeltaT when the chilling and warming device is operated in its warming mode would therefore be between 0 and 30 degrees C. Accordingly, the minimum actual Q in the warming mode would also be around 18 watts.

In actuality, the heat energy input into the chamber during the warming mode will be much greater than the 18 watts of heat pumped from the cold side of the TEC. During operation, the TEC heats up due to its internal resistance to the electric current passing through it. This heat must be dissipated through the hot side of the TEC. The magnitude of this resistive heat is essentially the product of I (in amps) and V (in volts), which in the TEC profiled in FIG. 2 is about 38 watts. Accordingly, the actual energy input into the chamber and the baby bottle would be around 56 watts or more. The resistive heat energy is particularly advantageous in the chilling and warming device as it helps in warming the baby bottle more quickly.

In order for a particular TEC to be adequate for chilling a baby bottle contained in the chamber of a chilling and warming device, the heat pumping capacity of the TEC must be greater than the passive heat load incident on the chamber. Passive heat load refers to heat that either enters the chamber through conduction, convection or radiation while the device is in the chilling mode or heat that escapes from the device when it is in the warming mode. Relatively, the amount of heat gained or lost due to convection or radiation is typically small compared to the heat gained or lost through conduction. By sufficiently insulating the chamber the amount of heating due to conductivity can be significantly reduced. Obviously, if the passive heat load exceeds the heat pumping capacity of the TEC, the temperature in the chamber will not be reduced appreciably. Generally, if the container is reasonably insulated the passive heat load will be relatively small such that a TEC with a Q of only 1-2 watts could typically overcome any incident passive heat load.

However, to actually chill the baby bottle and the formula or milk contained therein, the heat pumping capacity of the TEC must be sufficiently greater than the passive heat load so that heat from the baby bottle and other elements in the chamber can removed in a timely manner to lower the temperature of the formula or milk to the desired level. For example, 4 ounces of formula in a baby bottle require approximately 2700 calories to be cooled from 20 degrees Celsius to 5 degrees Celsius. The aluminum portion of a chilling and warming device's chamber and the plastic baby bottle may require around another 1000 calories to be cooled the same amount depending on their mass and their composition. Assuming there is a passive heat load of 1000 calories an hour incident on the chamber, approximately 20 minutes will be required to cool the formula or milk to 5 degrees C. using a TEC with a Q of 18 (18 watts are roughly equivalent to about 17,000 calories per hour). It is to be appreciated that the actual time required to cool the liquid to 5 degrees may be significantly greater than 20 minutes due to limiting heat transfer rates. Nonetheless, a TEC with a Q of 18 would be much more than adequate to cool a baby bottle. The actual time required to completely cool 4 ounces of ambient temperature liquid contained in a baby bottle in a refrigerator can take over 60 minutes and larger volumes of containerized liquids take even longer. Therefore, a TEC that can cooled a baby bottle containing 4-8 ounces of fluid to around 5 degrees C. from ambient in less than 90 minutes would generally be acceptable for use in the chilling and warming device in a chilling mode. Accordingly, TECs having minimum Q's of at least 4 watts would typically satisfy this criteria.

A TEC used in the first, second and third embodiment devices should preferably be capable of rapidly heating the formula or milk contained in the baby bottle up to the desired elevated temperature, especially with the manually operated embodiments of the device. Concerning the automated operation of certain embodiments of the device, heat up speed is not as critical because the device is configured to have the bottle warmed to the specified temperature by the predetermined feeding time (also referred to as target time herein) so that the caregivers typically will not have to wait for the bottle to heat up. But in the occasional circumstances when the baby wakes prior to the scheduled time, the caregiver is still going to desire the ability to warm the bottle up as fast as possible using the manual override feature. Accordingly, a TEC that will facilitate warming a bottle with 6 ounces of liquid from 5 degrees Celsius to 35 degrees C. in (i) about 20 minutes is preferred, (ii) about 15 minutes is more preferred, and (iii) less than 10 minutes is most preferred. Approximately 7400 calories are required to heat 6 ounces of formula or milk, the baby bottle and the chamber from 5 degrees C. to 35 degrees C. A TEC having a Q of around 18 watts (such as the one discussed above) has a heating capacity of about 56 watts (roughly 54,000 calories per) hour. Therefore, after a 1000-calorie@hour passive load loss is factored in, the TEC will warm the milk or formula to the desired temperature in about 8-9 minutes (assuming efficient heat transfer and no other heat losses). Considering the desired heat up times, a TEC having a total heating capacity of at least 27 watts, more preferably at least 35.6 watts and most preferably at least 52.8 watts is desired for use in a warming a chilling device that relies upon the TEC in both the warming and chilling modes.

In certain alternative embodiments not described in detail herein, the TEC could be replaced with alternative active cooling apparatus, such as but not limited to a mini-compressor refrigeration system. It is appreciated that if a TEC is replaced with a different type of active cooling system, a separate heating system, such as but not limited to a resistive heater, may be required to heat the milk or formula in the warming mode. Further alternative types of heat pump technology can be utilized in place of the TEC that perform both the warming and cooling functions.

A First Embodiment

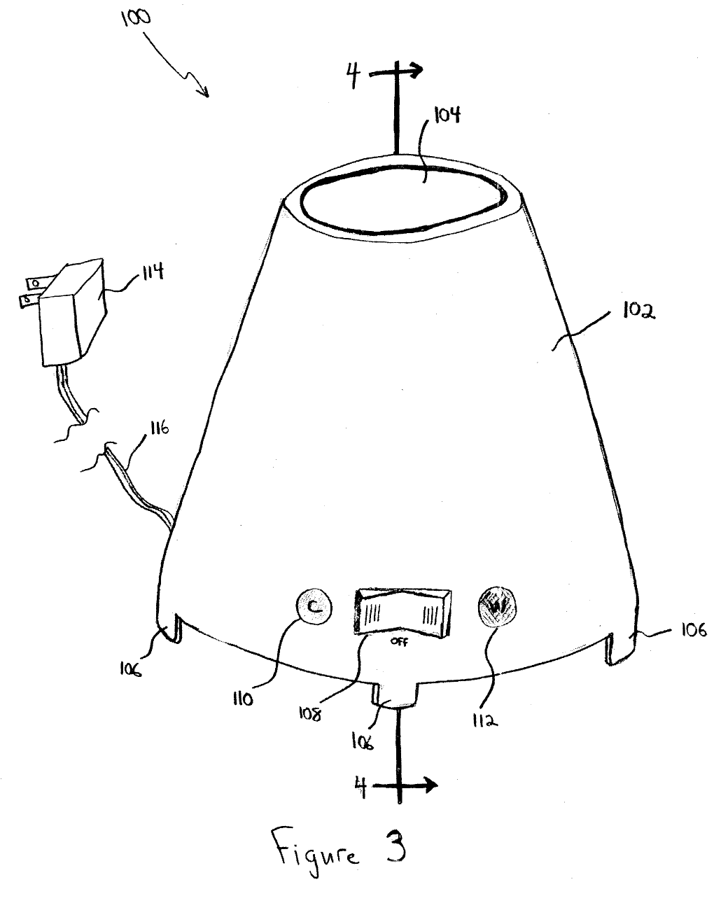

A first embodiment chilling and warming device 100 is illustrated in FIGS. 3-6.

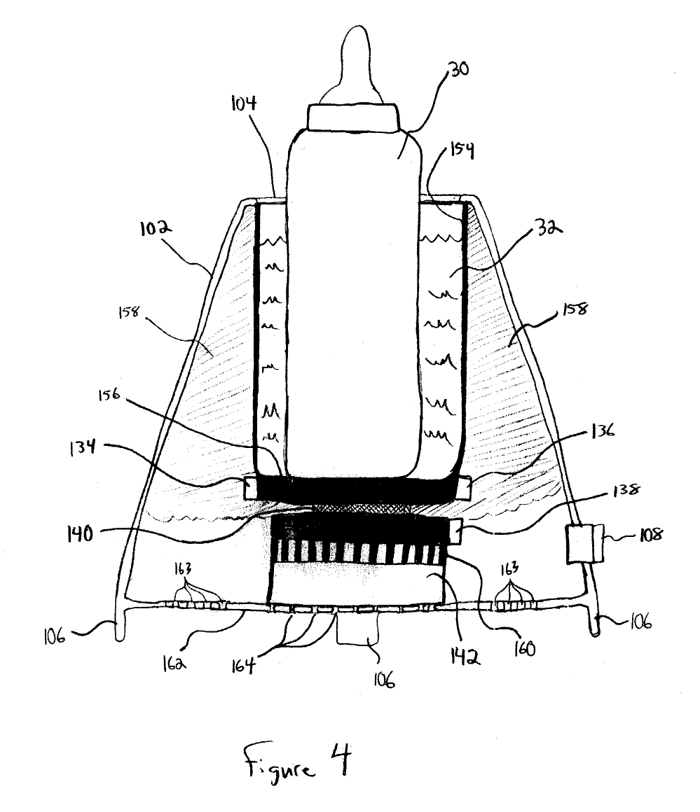

Referring primarily to FIG. 3, the device includes an outer shell 102. In a preferred configuration, the shell is comprised of a plastic material that is injection molded in as a single unit. Alternatively, the shell can be fabricated form other types of material and in other configurations. The shell defines an opening 104 at its top providing access to a single baby bottle chamber 154 (as shown in FIG. 4). Legs 106 extend downwardly from the bottom of the shell and in a preferred configuration are integrally molded with the shell.

On the front side of the shell a three-way rocker switch 108 is provided to place the device in one of a warming mode, a chilling mode or off. Other types of switches could be used as well including but not limited to one or more push buttons, a slider switch, a toggle switch and a dial. Indicator lights 110 & 112 are provided on either side of the: switch to indicate whether the device is in the chilling or warming mode. Preferably, the chilling mode indicator light 110 is blue and the warming mode light 112 is red.

An electrical cord 116 extends from the device and terminates in AC plug, which is part of a power supply 114. The TEC utilized to provide for the warming and chilling of the baby bottle chamber operates on DC voltage only. Accordingly, AC voltage from the AC source must be converted into DC voltage by the power supply. In the first embodiment illustrated in FIG. 1, a wall mounted power supply 114 is utilized. The power supply transforms the voltage to the level utilized by the TEC (typically 5-16 v) and transforms the AC voltage to a DC voltage. The process of stepping down an AC voltage and transforming the voltage into a DC waveform generates a significant amount of waste heat. By locating the power supply away from the device's shell 102 and chamber 104, the waste heat generated by the power supply will not hinder the efficiency of the device, especially when the device is in its chilling mode. In alternative embodiments, the power supply can be located within the shell of the device. Although depending on the design and configuration of an internal power supply, a power supply cooling fan may be required to evacuate the excess heat.

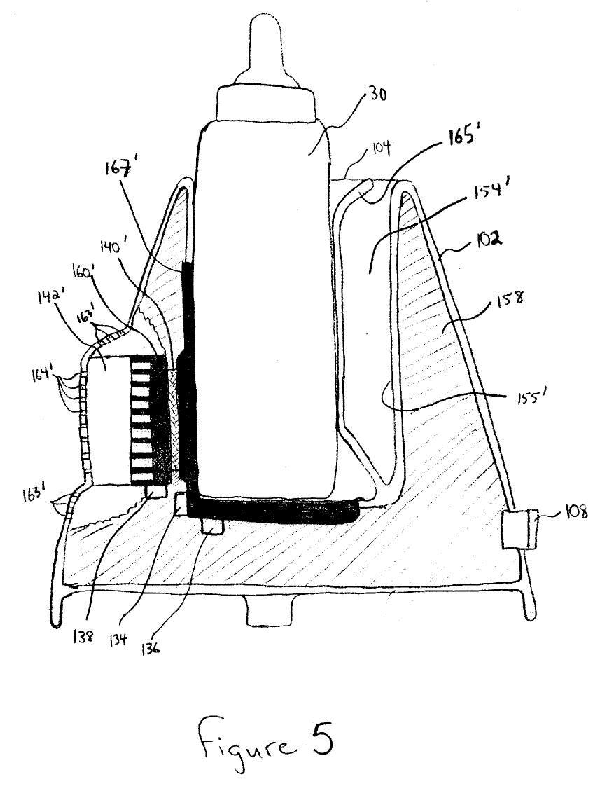

Referring to FIGS. 4 and 5, cross sections of first and second variations of the first embodiment of the chilling and warming device are illustrated. The baby bottle chamber is generally centered within the shell 102. The chamber is typically cylindrical in configuration and has a diameter sufficient to receive a variety of types of baby bottles therein. Preferably, at least a portion of the chamber is fabricated from aluminum or another metallic material having a high thermoconductivity to assist in the transfer of heat to and from a baby bottle received in the chamber during the device's operation, although in alternative variations other plastic, ceramic or other materials having a relatively high thermoconductivity can be utilized. An insulating material 158 surrounds the chamber. The insulating material is preferably comprised of a polymeric foam material such as polyurethane or polystyrene, although other types of insulating material can be utilized including but not limited to fiberglass batting and an evacuated void.

In the first variation as illustrated in FIG. 4, the chamber 154 is comprised substantially of an aluminum cup having a relatively thick bottom wall 156 (about 0.125-0.375″) and thinner sidewalls (about 0.050-0.0125″). The chamber is substantially watertight. Operationally, the baby bottle 30 to be chilled and/or warmed is placed in the chamber and a quantity of fluid 32, preferably water, is added to the chamber to provide a heat transfer medium between the walls of the chamber and the walls of the baby bottle. It is appreciated that direct conduction of heat also occurs between the bottom wall of the baby bottle and the top side of the bottom wall of the chamber, which are typically in direct contact. Alternatively, the chamber may comprise a relatively small area of high conductivity material, such as aluminum, typically at the bottom wall of the chamber in thermal contact with the TEC that heats the bottom of the bottle and the fluid 32. In this alternative configuration, the remainder of the chamber can be comprised of a material of relatively low thermal conductivity, such as many plastics.

A top face of a TEC 140 is thermally coupled with the bottom side of the chamber's bottom wall 156. The opposing bottom face of the TEC is thermally coupled to a heat sink 160. Preferably, the TEC is adhesively joined to both the heat sink and the bottom wall of the chamber, although the TEC may also be held in place by mechanical means, such as screws spanning between the heat sink and the chamber's bottom wall. As illustrated in FIG. 4, the thermoelectric module is in direct contact with both the heat sink and the chamber. In alternative variations, intervening cold/hot plates made of a thermally conductive material, such as aluminum or copper, can be provided, while still maintaining a thermal coupling between the thermoelectric module and the respective chamber and heat sink. A fan 142 rests on a bottom wall 162 of the shell 102 and faces the heat sink. Operationally, the fan sucks ambient air from beneath the device through air holes 164 and blows the air through the fins of the heat sink and out of the device through vent holes 163. The ambient air is either heated or cooled as it passes through the heat sink fins.

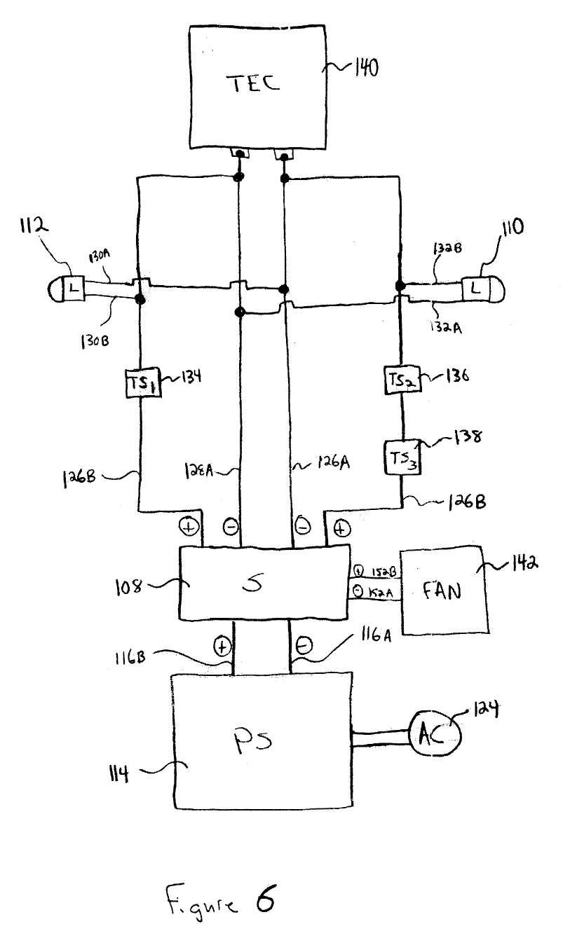

The TEC 140 is electrically coupled with the power supply 116 by way of an electrical circuit that includes a three-way toggle switch 108, and three thermal switches. First and second thermal switches 134 & 136 are thermally coupled to the top face of the thermoelectric module by attachment with the aluminum chamber. A third thermal switch 138 is thermally coupled to the bottom face of the thermoelectric module by attachment to the heat sink 160. The preferred thermal switches comprise inexpensive bimetal thermostats that open and close at or around a particular temperature. The thermal switches, however, can also include solid state thermally activated switching devices. The wires and electrical traces connecting the various components of the electrical circuit and their operation are discussed in detail below with reference to FIG. 6.

In the second variation of first embodiment device as illustrated in FIG. 5, the chamber 154 comprises a plastic portion 155′ including a bottle clip 165′ and an aluminum generally L-shaped portion 167′ that abuts the plastic portion. The plastic portion can be integrally molded with the shell 102 or may comprise a distinct part that is adhesively, mechanically or thermally joined to the shell. The bottle clip can be integrally formed with the plastic portion of it can comprise a separate part. The bottle clip acts to bias a baby bottle 30 inserted into the chamber against the vertical and horizontal sidewalls of the L-shaped portion. The horizontal bottom wall of the L-shaped portion is generally flat and comprises most of the bottom wall of the chamber. The vertical sidewall of the L-shaped portion is generally arcuate having an effective radius in a horizontal plane of about 1.00-1.50″ so as to increase the surface area of contact with the arcuate sidewall of the baby bottle. The chamber is substantially surrounded by insulation 158 to slow the rate of heat transfer in or out of the chamber.

A first face of a TEC is thermally coupled to the L-shaped portion. A second opposing face of the TEC is thermally coupled to a heat sink 140′. Similar to the thermoelectric module of the first variation, the TEC is adhesively joined to both the heat sink and the bottom wall of the chamber, although the TEC may also be held in place by mechanical means, such as screws spanning between the heat sink and the chamber's bottom wall. A fan 142′ spans the distance between the finned side of the heat sink and the second face of the TEC. Operationally, the fan sucks ambient air from outside of the device through air holes 164′ and blows the air through the fins of the heat sink and out of the device through vent holes 163′. The ambient air is either heated or cooled as it passes through the heat sink fins.

Like the first variation, first and second thermal switches 134 and 136 are thermally coupled with the first face of the TEC, and a third thermal switch 138 is thermally coupled to the second face of the TEC. An electrical circuit electrically couples the TEC to the power supply 114 through the thermal switches and the rocker switch 108 in a manner substantially similar to the first variation as shown in FIG. 5 and as described below. Referring to FIG. 6, the electrical circuit of the first embodiment is illustrated. The power supply 114 is typically connected to an AC power source 124, typically through a household receptacle. The power supply is electrically connected with the rocker switch 108 through electrical traces 116A & B. The term “electrical traces” as used herein refers to any conductive path along which electrical current travels. Electrical traces can include, but are not limited to, metallic traces on a circuit boards and electrical wires. The fan 142 is coupled to the switch 108 through traces 152A & B and can be wired to either remain activated when the device is in either the chilling or warming mode or only when the device is in the chilling mode.

When the rocker switch is switched to the warming position, current generally flows through the thermoelectric module along a first electrical path defined by first and second electrical traces 126A & 126B. The warming indicator lamp 112 is connected in parallel with the TEC through traces 130A & B along the first path and is lit whenever current is flowing through the first path. Alternatively, the indicator lamp can be connected with the TEC 140 in series along the first path; however, in this configuration a failure of the lamp would prevent the device from operating in the warming mode. The first thermal switch 134 is electronically coupled in series with the TEC along the first path. The first thermal switch is normally closed at ambient temperatures and opens when the temperature of the chamber to which it is attached exceeds a preset high temperature value, such as 35-45 degrees Celsius, thereby interrupting the flow of current to the thermoelectric module and stopping the generation and pumping of heat to the chamber. This prevents the contents of the baby bottle from being overheated. When the temperature of the chamber and the first thermal switch drops to a temperature 1-3 degrees Celsius below preset high temperature value, the switch recloses thereby allowing current to flow again through the first path. One type of thermal switch that can be used for the first, second and third thermal switches is the 4286 Series Klixon thermostat by Texas Instruments, Inc.

When the rocker switch 108 is switched to the chilling position, current generally flows through the TEC 140 along a second electrical path defined by third and forth electrical traces 128A & 128B. The chilling indicator lamp 110 is connected in parallel with the thermoelectric module through traces 132A & B along the second path and is lit whenever current is flowing through the second path. Alternatively, the indicator lamp can be connected with the thermoelectric module in series along the second path; however, in this configuration a failure of the lamp would prevent the device from operating in the chilling mode. The second and third thermal switches 134 are electronically coupled in series with the thermoelectric module along the second path. The second thermal switch 136 is also normally closed at ambient temperatures but opens if the temperature of the chamber falls below a low temperature value, such as 2-10 degrees Celsius. This prevents the contents of the bottle from being frozen. When temperature of the chamber warms 1-3 degrees Celsius, the second thermal switch recloses thereby allowing current to again flow through the second path. The third thermal switch 138 is normally closed at ambient temperatures and opens when the temperature of the heat sink to which it is attached exceeds a preset temperature value, thereby interrupting the flow of current to the TEC and stopping the pumping of heat out of the chamber. This prevents the TEC from overheating while operating in the chilling mode. When the temperature of the chamber and the first thermal switch drops to a temperature 1-3 degrees Celsius below preset temperature value, the switch recloses thereby allowing current to flow again through the second path.

A number of modifications to the electrical circuit of the first embodiment device are contemplated. For instance, one or more of the thermal switches can be connected in series along electrical traces 116A & B. Further in a variation of the device where the power supply is located at least partially inside of the device's shell, one or more of the thermal switches can be located in series with electrical traces that carry AC voltage from the source to the power supply prior to conversion into DC voltage. In another variation, the power supply is not utilized. Rather, a connection is provided to attach the circuit at traces 116A & B to a battery. For example, the connection can be an automotive cigarette lighter adapter, permitting the use of the chilling and warming device in an automobile. In other variations, the fan 142 can be electrically coupled to the circuit in a variety of locations including AC voltage traces providing an AC fan is utilized. Other variations are contemplated as would be obvious to one of ordinary skill in the art with the benefit of this disclosure.

A Second Embodiment

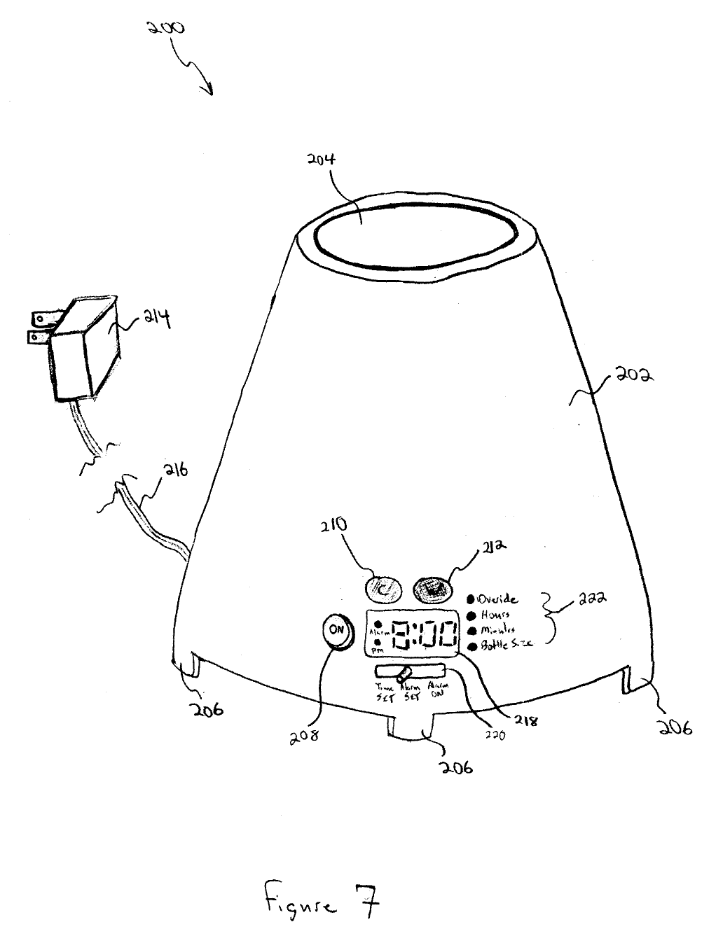

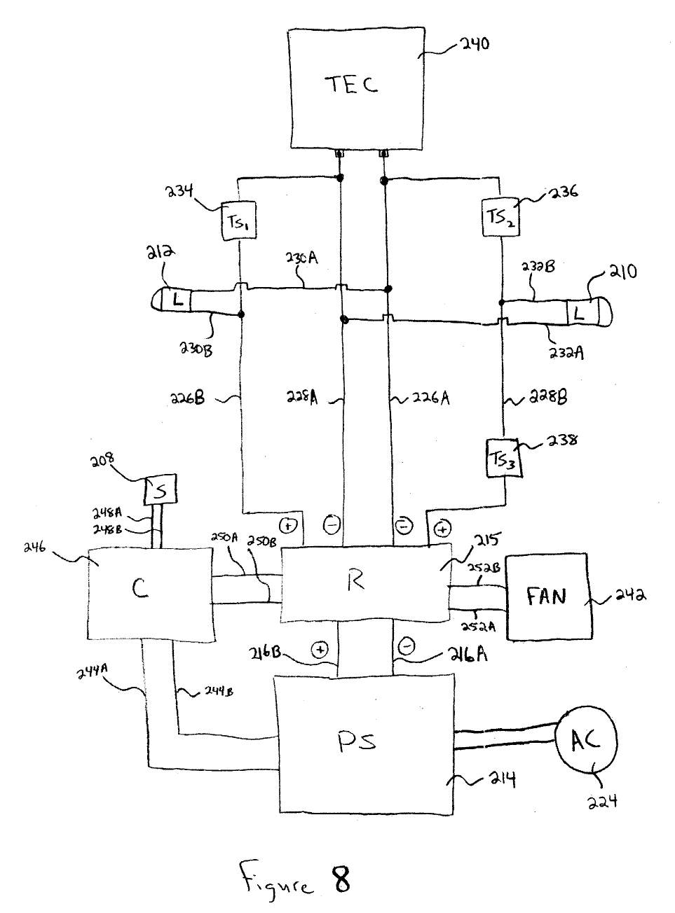

A second embodiment chilling and warming device 200 is illustrated in FIGS. 7 and 8.

Referring primarily to FIG. 7, the device includes an outer shell 202 that is generally similar to the outer shell 102 of the first embodiment device 100. The shell defines an opening 204 at its top providing access to a single baby bottle chamber substantially similar to the chamber illustrated in either FIGS. 4 or 5. A plurality of legs 206 extend downwardly from the bottom of the shell and are integrally molded with the shell. An electrical cord 216 extends from the device and terminates in a wall mounted power supply 214.

On the front side of the shell, a push button switch 208 is typically provided for turning the device on and off. Indicator lights 210 & 212 are provided to indicate whether the device is in the chilling or warming mode. Further, a clock display 218 of a clock circuit 246 (see FIG. 8) is provided for use in conjunction with various switches 222 and 220 for setting the time, an alarm and controlling the operation of the device. The display typically comprises a backlit LCD panel or an LED panel. A slider switch 220 preferably has three positions: a first for setting the time; a second for setting the alarm; and a third for turning the alarm of the clock circuit. Four push buttons 222 are provided for (1) entering the amount of fluid in a baby bottle to be warmed, (2) setting the hour and minutes of the clock and the alarm, and (3) manually overriding the automatic and timed operation of the device so that a user can place the device into the chilling or warming mode on demand. The configuration of the various switches and the clock display are provided merely as an example of one possible control and display layout, and accordingly, it is to be appreciated that the actual types and configuration of switches and display for control the clock circuit and the device can vary greatly.

A cross sectional view of the second embodiment is not provided herein. Except for the replacement of the rocker switch 108 with the a clock circuit along with its associated display and switches, the cross section of the second embodiment device is largely similar to the cross sections illustrated of the first and second variations of the first embodiment device in FIGS. 4 and 5.

Referring to FIG. 8, the electrical circuit of the second embodiment is illustrated. The power supply 214 is typically connected to an AC power source 224, typically through a household receptacle. The power supply is electrically connected with a relay 215 through electrical traces 216A & B. The relay has three operative positions: the first position sending DC voltage to a first electrical path defined by electrical traces 226A & B; the second position sending DC voltage to a second electrical path defined by electrical traces 228A & B; and an off position. The relay is switched between the three positions responsive to electrical signals transmitted to it from a clock circuit 246. The first and second paths of the second embodiment device's electrical circuit are substantially similar to the first and second paths of the first embodiment. The warming and chilling indicator lights 212 & 210 respectively are coupled with the first and second paths of the second embodiment in substantially the same manner as the indicator lights 112 & 110 of the first embodiment. Further, the construction, configuration and operation of the first, second and third thermal switches 234, 236 & 238 respectively are substantially similar to the first, second and third thermal switches 134, 136 & 138 of the first embodiment device. Additionally, a fan 242 is coupled to the relay 215 through traces 252A & B and can be wired to either remain activated when the device is in either the chilling or warming mode or only when the device is in the chilling mode.

The clock circuit 246 is typically electrically coupled with the power supply by traces 244A & B to receive power therefrom and with the relay through traces 250A & B to transmit electrical signals to the relay to cause the relay to switch from one position to another. Additionally, the clock circuit is electrically coupled the on/off push button switch 208 for activating the device. In one variation of the second embodiment, the clock circuit can be independently powered by its own battery. The clock continues to draw power from the power supply or its internal battery whether or not the device has been switched on via the push button switch. Rather, activating the on/off button switch permits the clock circuit to transmit switching signals to the relay.

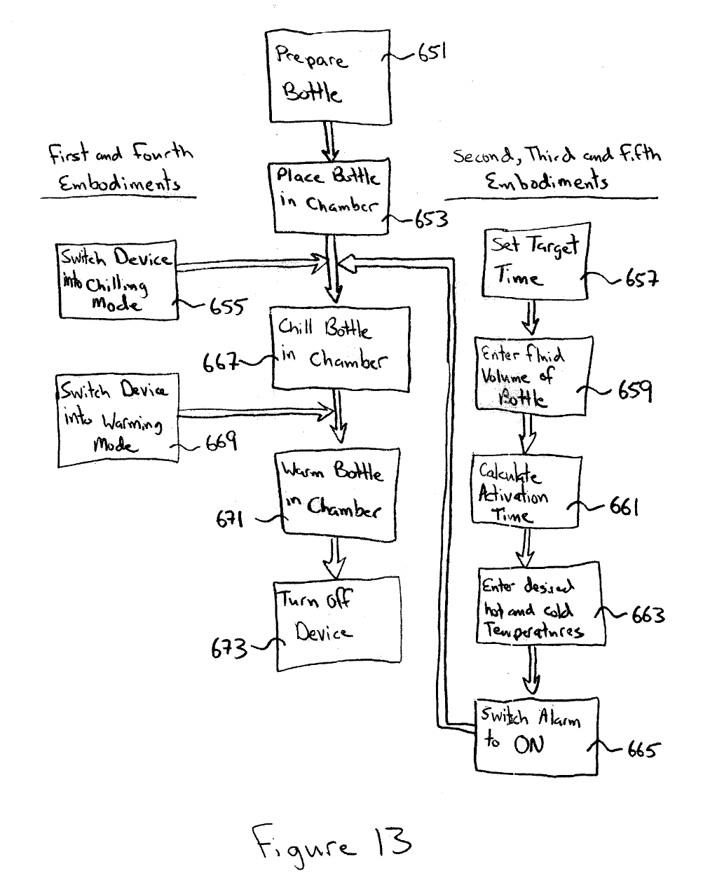

The clock circuit 246 typically is comprised of a clock chip and a simple microprocessor configured to calculate a warming mode activation time from a user entered alarm time (or target time) and signal the relay to switch modes at the activation time. Preferably, the clock circuit includes a speaker or buzzer to audibly alert the user when the alarm or target time has arrived. Further, the clock circuit can include an indicator light or LED that is lit or flashed when the alarm is triggered. The operation of the clock circuit is described in greater detail below with reference to FIG. 13.

Third Embodiment

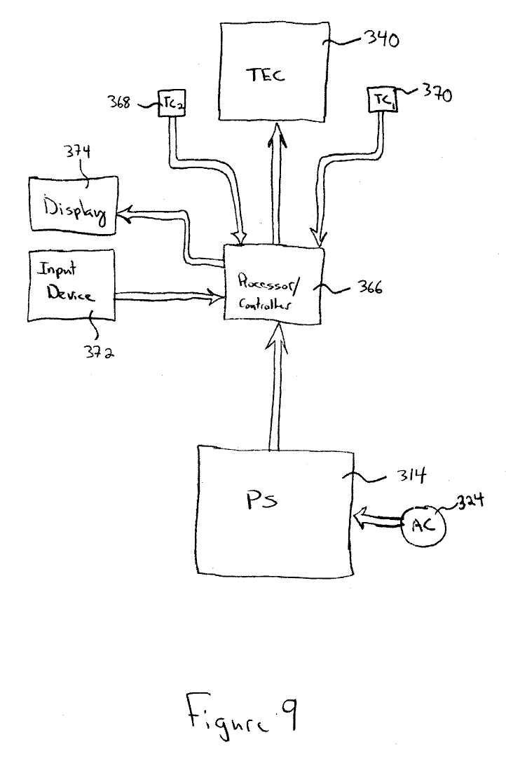

A block diagram illustrating the circuitry for a third embodiment chilling and warming device 300 is illustrated in FIG. 9. The exterior of the third embodiment is generally similar to the exterior view of the second embodiment as shown in FIG. 7, although in variations there are additional switches to permit the user to set the high and low temperatures of the chamber while the device is in the warming and the chilling modes respectively. A cross section of the third embodiment is similar to that of the first and second variations of the first embodiment as illustrated in FIGS. 4 and 5, except for the replacement of the rocker switch 18 with a display panel and control switches. Additionally, the third embodiment does not utilize thermal switches. Rather, a first thermocouple or first thermistor 368 is attached to the chamber and is thermally coupled to one face of the thermoelectric module and a second thermocouple or second thermistor 370 is attached to the heat sink and is thermally coupled to the opposing second face of the TEC.

Referring to FIG. 9, AC voltage is fed into a power supply 314 from an AC voltage source 324. The power supply is electrically coupled to a microprocessor-based controller 366 for providing DC voltage to the controller and a TEC 340. The controller includes a clock circuit with an alarm function similar to the circuit described above concerning the second embodiment. Further, the controller includes a microprocessor for regulating and controlling the operation of the device. The controller also typically includes a relay for providing DC voltage of the proper polarity to the TEC depending on the operation mode of the device.

An input device 372 in the form of various buttons and switches is coupled with the controller to permit a user to enter information such as the time, the alarm time, the temperature set points and the fluid volume of a bottle to be warmed into the controller. A display panel 374, typically comprised of LCDs or LEDs is provided to display the input information and the time. The display is adapted to provide the user with an indication whether the device is in the chilling or warming mode. Alternatively, separate indicator lights can be provided similar to those of the first two embodiments.

Based on the temperatures of the heat sink and the chamber as measured by the first and second thermistors 368 and 370 during the chilling mode, the microprocessor determines whether DC voltage should be sent to the TEC 340. In a simple controller, the microprocessor merely switches the relay off and on to provide simple binary control of the DC voltage sent to the TEC. However, in more sophisticated proportional controllers, the amount of voltage and/or amperage of the current can be varied proportionately to more precisely control the temperature of the chamber. For instance as the temperature in the first thermistor 368 approaches the set low temperature, the microprocessor in a proportional controller might reduce the voltage supplied to the TEC to reduce its effective Q value. In an on/off controller, the microprocessor simply switches the supply of DC voltage to the TEC off when the low temperature is achieved and does not restore power until the temperature rises a certain amount above the set point. Further, the voltage or the current provided to the TEC is reduced or shut off if the temperature of the heat sink as measured by the second thermistor 370 approaches or exceeds a safe level.

During the warming mode, the microprocessor/controller 366 monitors the temperature of the first thermistor 368. In a proportional-type controller, the microprocessor various the voltage and/or amperage provided to the TEC as the temperature of the chamber approaches a high temperature set point. In the off/on-type controller, the microprocessor turns off power to the TEC when the high temperature set point is exceeded.

Fourth and Fifth Embodiments

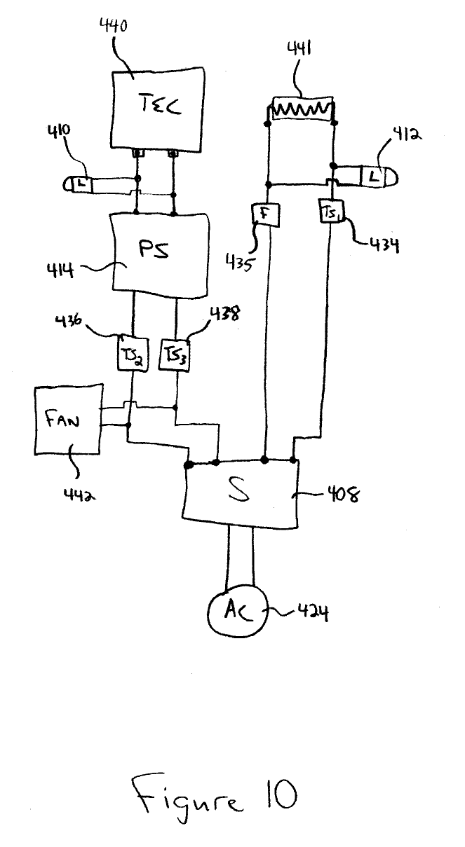

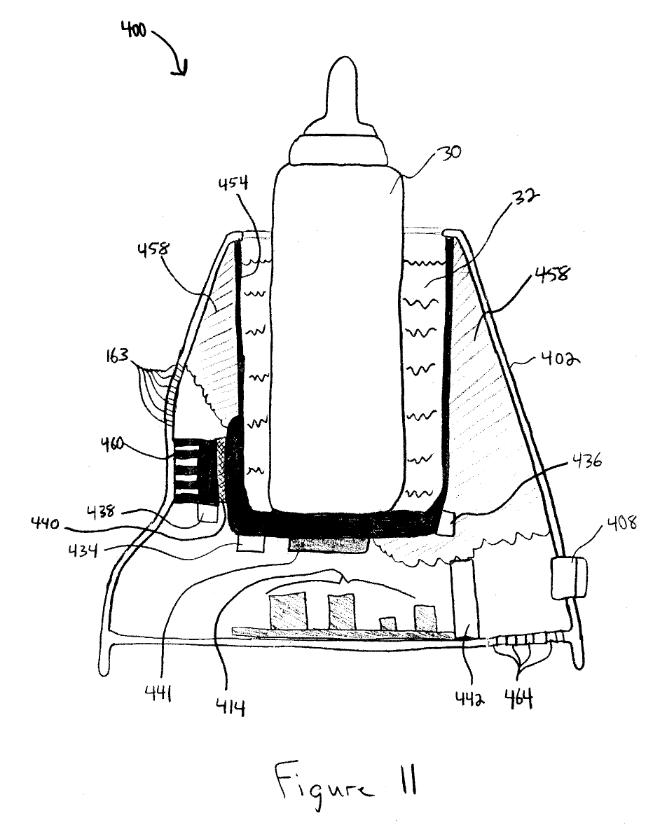

The circuit diagrams for fourth and fifth embodiment devices are illustrated in FIGS. 10 and 11 respectively. The fourth and fifth embodiments differ from The previously described embodiments in that they utilize a separate resistive heater 441 and 541 to warm an associated chamber and rely on the TEC 440 and 540 only for chilling the chamber. As discussed in detail above, a TEC having a relatively low Qmax value (around 4 watts) is suitable for performing the chilling function of the chilling and warming device. TECs with higher Qmax values (greater than 15 watts) are utilized in the first three embodiments largely because of the need to rapidly warm the baby bottle and its contents. Larger and more powerful TECs tend to be slightly more expensive than less powerful TECs. Additionally, the more powerful TECs require a more powerful power supply to convert AC voltage into DC voltage and such power supplies can be substantially more expensive than less powerful units. Finally, the higher-powered TECs require the use of more robust and consequently more expensive relays, switches and controllers.

When a separate heating element 441 and 541 that utilizes AC voltage directly without conversion to DC voltage is used as in the fourth and fifth embodiment devices, the size and power of the TEC can be reduced substantially, thereby decreasing the cost of ancillary components such as the power supply and the associated relays and switches. Further, a heating element having a higher heat capacity can be utilized to decrease the time it takes to heat the chamber up to temperature.

The fourth embodiment is manually operated and typically has an exterior similar to that of the first embodiment as shown in FIG. 3. Further, the cross section of the fourth embodiment is typically similar to that of FIGS. 4 and 5 with the addition of a heating element attached to the aluminum portion of the chamber. Alternatively, as illustrated in FIG. 11, the power supply 414 for generating DC voltage for the TEC 440 can be located within the shell 402 of the device. Referring to FIG. 10, the heating element 441 can be of a variety of shapes and configurations including but not limited to a tape heater that surrounds the chamber and a block heat that is mounted to the side or bottom of the chamber. The heating element typically has a wattage rating of between 40-100 watts, although lower or higher capacity elements can be utilized. The heating element is coupled electronically to a rocker switch 408 that is generally similar to the rocker switch 108 of the first embodiment. When the switch is moved into the warming position, AC voltage flows through the warming portion of the circuit from an AC source 424, through a first thermal switch 434 and a fuse 478. The thermal switch is adapted to open and shut off the flow of electricity to the heater when the temperature of the chamber exceeds a high temperature value, such as 40 degrees Celsius and reclose when the temperature drops a certain amount below the high temperature value. The fuse is provided for safety purposes to break the circuit if the amperage flowing through the heating element exceeds a predetermined safe level as might occur if the heating element develops a short. A warming mode indicator lamp 412 that is similar to the indicator lamp 112 of the first embodiment is also provided.

The TEC 440 utilized in the fourth (and fifth) embodiments typically has a Qmax value of around 4-8 as compared to a typical Qmax value of around 12-30 for the TEC of the first three embodiments. The TEC is electronically coupled to a power supply 414. The power supply which is generally smaller and of a lower power rating than the power supplies of the first three embodiments can be a wall mounted unit or can be mounted within the shell 402 of the fourth embodiment device. The power supply is connected to the rocker switch 408. An AC powered cooling fan 442 is typically provided between in parallel between the switch and the power supply to dissipate heat of a heat sink 460 coupled with the TEC. In the variation illustrated in FIG. 11, the fan is also configured to dissipate heat generated by the power supply. In another variation, a fan may not be required given the lower amounts of heat generated by the low power TEC utilized in this embodiment. Second and third thermal switches 436 and 438 that operate in a similar manner to the second and third thermal switches 136 & 138 of the first embodiment are also provided to ensure the chamber is maintained at the proper temperature while the device is operating in the chilling mode.

The fifth embodiment device utilizes a separate AC powered resistive heating element 541 for the warming mode in a similar manner as the fourth embodiment device, but also includes a clock circuit 546 to permit the automatic operation of the device. The exterior of the device is generally similar to the second embodiment device as illustrated in FIG. 7. Further, the cross section of the fifth embodiment device is substantially similar to that of FIGS. 4 and 5 with the addition of a heating element attached to the aluminum portion of the chamber and the substitution of a relay 515 and clock circuit for the rocker switch. Alternatively, the fifth embodiment device can have a cross section similar to that of the fourth embodiment device as illustrated in FIG. 11.

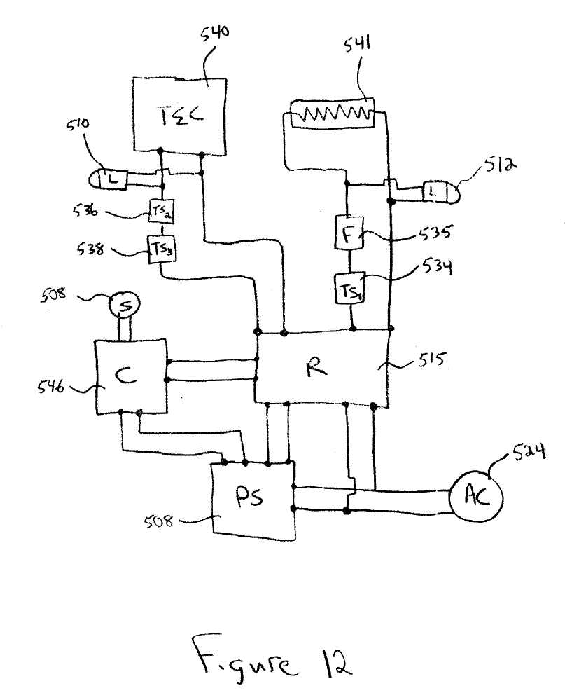

Referring primarily to FIG. 12, the heating element 541 is coupled with a relay switch 515 much in the same manner as the heating element in the fourth embodiment is coupled with the rocker switch 408. Accordingly, when the relay is switched into the warming mode electricity, AC voltage from the AC source 524 flows through the heating element. A first thermal switch 534 and a fuse 535 are electrically coupled with the heating element in series and perform substantially the same function as the similar components in the fourth embodiment device.

The TEC 540 of the fifth embodiment device is also coupled to the relay switch 515 and when the relay switch is in its chilling mode, DC voltage flows from a power supply 508 through the relay 515 to the TEC. Second and third thermal switches 536 and 538 that are substantially similar and perform substantially the same function as the second and third thermal switches of the fourth embodiment are electrically coupled with the TEC in series. Finally, a clock circuit 546 that is generally similar in configuration and operation to the clock circuit of the third embodiment is coupled to the relay to provide electrical signals to the relay for switching between the off position and the chilling and warming modes. Further, an on/off button 508 is provided for activating and deactivating the device, and indicator lights 410 and 412 are provided to indicate whether the device is in the chilling or warming mode.

Operation of the Chilling and Warming Device

The process of using the various embodiments of the chilling and warming device is described with reference to the block diagram of FIG. 13. As indicated in blocks 651 and 653, a caregiver prepares a baby bottle by filling it with the appropriate amount of formula, breast milk or other fluid and places the bottle in the device's chamber. It is appreciated that the initial temperature of the fluid is not critical. It may be room temperature, warmed, or chilled.

Next, concerning the first and fourth embodiment devices, the caregiver switches the device into the cooling mode via the rocker switch 108 or 408 as indicated by in block 655.

If second, third or fifth embodiment device is utilized, the caregiver enters the target time (also alarm time) into the device as shown in block 657. The target time is the desired time that the baby bottle and its contents will be fully warmed. The device must begin warming the bottle at a time, referred herein as the activation time, a number of minutes before than the target time. An alarm typically sounds when the target time is reached to notify the caregiver that it is feeding time and that the bottle is ready. The difference between the activation and target times depends on the volume of fluid in the baby bottle that requires warming: the greater the amount of fluid the longer the bottle will take to warm. Accordingly, the caregiver typically enters the volume of fluid in the baby bottle into the device as shown in block 659. The processor in either the controller or the clock circuit determines the activation time based on the target time and required warming time for a baby bottle containing the entered volume of fluid as indicated in block 661. For instance, if the target time is 1:00 AM, the baby bottle has 4 ounces of formula in it and the warming time programmed into the clock circuit or controller is 8 minutes for a 4 ounce bottle, the device would beginning the warming mode at approximately 12:52 AM. In block 665, the caregiver then switches the device into “on” position typically causing the device to enter its chilling mode until activation time when the device automatically switches into the warming mode.

The difference between the target time and activation time is a preset value for baby bottles containing different volumes of fluid; however, other factors such as the diameter and length of a baby bottle can also significantly effect the required warming time. Accordingly, some baby bottles may warm up faster or slower than other baby bottles containing the same amount of liquid. The target time therefore is not necessarily the actual time when the bottle and its contents will be fully warmed, but the target time will typically be close to the actual time. In the preferred embodiments, the device will continue to maintain the bottle at the warmed temperature for a period after the target time has passed.

In variations of the second, third and fifth embodiments, the caregiver can set the activation time instead of the target time. Accordingly, the device may not include any the ability to enter the volume fluid in the baby bottle. Since the required times to warm up a baby bottle are generally under 15 minutes in any of the embodiments, the caregiver could spend the time required for the device to warm the bottle preparing the baby for feeding, such as changing the baby's diaper. Ideally, the bottle will be warmed or close to being fully warmed when the caregiver has finished preparing the baby for feeding.

As indicated in block 663, in certain embodiments, such as the third embodiment device, the caregiver can enter the desired cold and hot temperatures. As stated above, the ideal fully chilled temperature is typically believed to be around 5 degrees Celsius and the ideal fully warmed temperature is believed to be around 40 degrees Celsius. However, different caregivers may desire different chilled and warmed temperatures. For example, a particular baby may prefer his/her bottle at 45 degrees Celsius, or the caregiver may desire that the bottle be chilled to 10 degrees instead of 5 degrees. When the temperatures are changed, it is appreciated that the times required to warm a bottle of a certain volume will vary as well. Accordingly, a lookup table is typically programmed into the controller that contains expected warming and chilling times for various fluid volumes and various combinations of warmed and chilled temperatures.

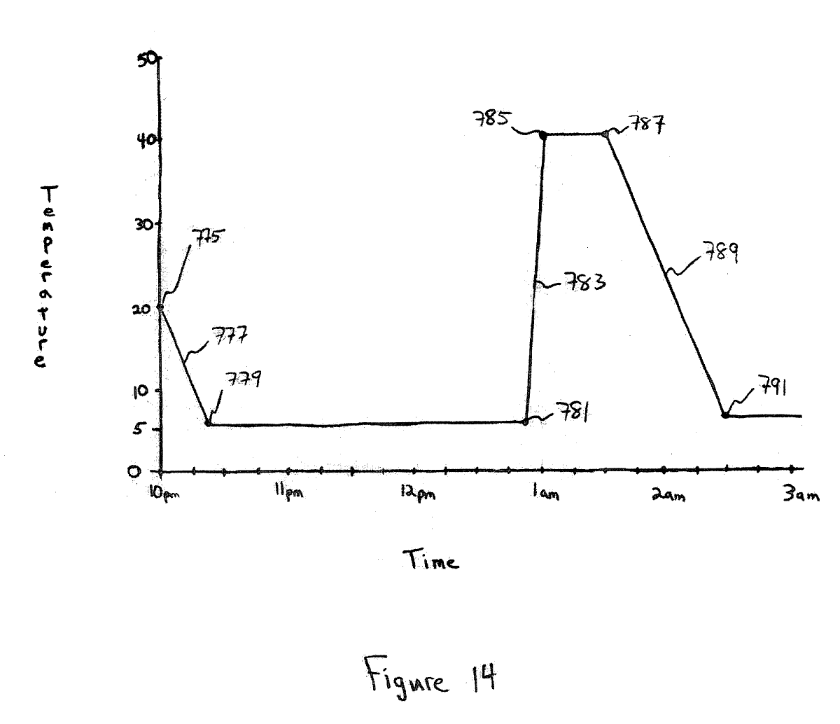

Referring to block 667, once the device is put into its chilling mode the baby bottle is chilled to the predetermined or desired temperature (typically 5 degrees Celsius). In a typical device having an effective Q value of around 15 watts, between 15 and 30 minutes are required to cool the bottle from an ambient temperature 775 of around 20 degrees to the chilled temperature 779 of 5 degrees during the cooling phase of the chilling mode as indicated by line 777 as shown in the Time-Temperature chart of FIG. 14. FIG. 14 profiles exemplary chilling and warming mode operations of a chilling and warming. Once the fully chilled temperature is achieved, the chamber device is maintained at that temperature until it is turned off or the warming mode is initiated.

Referring to block 669, in the first and fourth embodiment devices, the caregiver manually switches the device from the chilling mode into the warming mode to cause the device to begin to warm the baby bottle and its contents as indicated in block 671.

In the second, third and fifth embodiment devices, the device automatically switches from the cooling mode to the warming mode at the activation time to warm the bottle as indicated by block 671. Depending on the variation of the second, third and fifth embodiment devices, an alarm may be triggered to notify the caregiver. The alarm may also be triggered at a preset target time several minutes after the activation time.

Referring to the example operational cycle of FIG. 14, the warming mode is initiated at an activation time 781 to fully warm the baby bottle by a 1:00 AM target time 785. The heat-up phase of the warming mode is indicated by line 783. Once the fully warmed temperature is achieved, the chamber and the bottle is maintained at the elevated temperature until (i) the device is switched off as indicated by block 673 of FIG. 13, (ii) a certain amount of time has passed, such as 45 minutes or so as indicated at time 787 in the example operational cycle; or (iii) the bottle is removed from the chamber (in variations of the devices having a sensor to detect the presence of a baby bottle in the chamber). If the device automatically switches out of the warming mode after a certain amount of time, the device may shut itself off or as indicated by line 789 of FIG. 14, it may return to the chilling mode and chill the chamber until the fully chilled temperature is achieved at point 791, wherein the chamber is maintained at that temperature until the device is turned off.

Alternative Embodiments

A large number of additional alternative embodiments of the device are contemplated by combining the various features of the embodiments described herein. Accordingly, the invention is intended to encompass the full scope of the appended claims.

Additional features can be added to the described embodiments such as sensors to indicate whether a bottle is received into the chamber. Further, a device having two or more chilling and warming chambers is contemplated for independently or simultaneously chilling and warming two or more bottles as might be necessary when feeding multiple babies. The operation cycle described herein is only exemplary and the operations performed while utilizing the device can very in sequence. Finally, although the device is described for use with a baby bottle, it is appreciated that variations of the device can be adapted for use with baby food containers and other types of fluid containers, such as cans and glasses that are not related to feeding a baby.

I claim:

1. A device for chilling and warming a baby bottle, the device comprising:
a chamber adapted for at least partially receiving a baby bottle therein;
a thermoelectric module (TEC), the TEC having a first face and a second face, the first face being thermally coupled with the chamber;
a DC Power supply; and
an electrical circuit electrically coupling the DC power supply with the TEC, the electrical circuit including (i) one or more switching mechanisms for reversing the direction of current flow through the TEC, the TEC cooling the chamber when current flows in a first direction and warming the chamber when the current flows in a second direction, (ii) a clock circuit including a first function, the first function permitting a user to select one of (a) an activation time for switching the device from a chilling mode to a warming mode and (b) a target time for ending a heat-up phase of the warming mode, activation of the first function at a time relative to one of the activation time and target time causing the one or more switching mechanisms to reverse the direction of current flow through the TEC.

2. The device of claim 1, wherein the clock circuit includes an alarm, the alarm being either or both visual and audible and being activated at least one of (1) the time the first function is activated, (2) the target time and (3) the activation time.

3. The device of claim 1, further comprising a heat sink assembly, the heat sink assembly including a heat sink and a fan, the heat sink being thermally coupled with the second face of the TEC.

4. The device of claim 1, wherein the user to selects the target time, and the clock circuit further includes a second function permitting the user to input the volume of fluid contained in the baby bottle, the clock circuit being further adapted to determine the time for activating the first function based on the input volume.

5. The device of claim 1 wherein the time of activation of the first function and the activation time are the same.

6. The device of claim 1, wherein the electrical circuit further comprises a first thermal switch, the first thermal switch being thermally coupled with the first face and adapted to interrupt the flow of current to the TEC when a first temperature is exceeded.

7. The device of claim 6, wherein the first thermal switch comprises an open-on-rise bimetal thermostat.

8. The device of claim 6, further comprising a second thermal switch, the second thermal switch being thermally coupled with the second face of the TEC, the second thermal switch adapted to interrupt the flow of current to the TEC when a second temperature is exceeded.

9. The device of claim 6, further comprising a third thermal switch, the third thermal switch being thermally coupled with the first face, the third thermal switch adapted to interrupt the flow of current to the TEC when a temperature of the third thermal switch drops below a third temperature.

10. The device of claim 9, wherein the third thermal switch comprises an close-on-rise bimetal thermal switch.

11. The device of claim 1, wherein the electrical circuit further comprises an electronic controller and a first temperature sensor, the first temperature sensor comprising one of a thermocouple or a thermistor, the first temperature sensor being electrically coupled with the electronic controller and thermally coupled with the first face, the electronic controller being adapted to interrupt the flow of current to the TEC when the first temperature sensor exceeds a first temperature.

12. The device of claim 11, wherein the electronic controller is further adapted to interrupt the flow of current to the TEC when the temperature of the first temperature sensor drops below a second temperature.

13. The device of claim 11, wherein the electrical circuit further comprises a second temperature sensor, the second temperature sensor being electrically coupled with the electronic controller and thermally coupled with the second face, the electronic controller being adapted to interrupt the flow of current to the TEC when the second temperature sensor exceeds a third temperature.

14. The device of claim 11, wherein the clock circuit is integrated on a chip with a microprocessor of the controller.

15. A device for chilling and warming a baby bottle, the device comprising:
a chamber adapted for at least partially receiving a baby bottle therein;
a thermoelectric module, the thermoelectric module having a first face and a second face, the first face being thermally coupled with the chamber;
a DC power supply; and
an electrical circuit, the electrical circuit electrically coupling the DC power supply with the thermoelectric module, the electrical circuit including (i) a first portion adapted to provide a flow of DC voltage in a first direction through the thermoelectric module to warm the chamber, the first portion including a first thermal switch, the first thermal switch being thermally coupled with the first face and adapted to stop the flow of DC voltage when a temperature of the first thermal switch exceeds a first temperature value, (ii) a second portion adapted to provide a flow of DC voltage in a second direction through the thermoelectric module to cool the chamber, the second direction being opposite the first direction, the second portion including a second thermal switch, the second thermal switch being thermally coupled with the second face and adapted to stop the flow of DC voltage when a temperature of the second thermal switch exceeds a second temperature value (iii) one or more switching mechanisms coupling the first and second portions to the DC power supply, the one or more switching mechanisms adapted to selectively supply DC voltage to one of the first portion, the second portion or neither the first and second portions.

16. The device of claim 15, wherein the second portion of the circuit further comprises a third thermal switch, the third thermal switch being thermally coupled to the first face and adapted to stop the flow of DC voltage when a temperature of the third thermal switch falls below a third temperature value.

17. The device of claim 15, wherein the electrical circuit further includes a clock circuit, the clock circuit being adapted to automatically switch the one or more switching mechanisms to reverse the flow of DC voltage to the thermoelectric module at a predetermined time.

18. The device of claim 15, wherein the first thermal switch is attached to the chamber.

19. The device of claim 15 further comprising a heat sink, the heat sink being coupled with the second face of the thermal electric module.

20. The device of claim 19, wherein the second thermal switch is attached to the heat sink.

21. A method comprising:
placing a baby bottle containing a fluid at least partially into a single chamber of a device for chilling and warming the baby bottle;
chilling the baby bottle while the baby bottle is at least partially contained in the single chamber; and
warming the baby bottle without removing the baby bottle from the single chamber subsequently to chilling the bottle.

22. The method of claim 21, wherein said chilling the baby bottle includes providing a DC voltage in a first direction to a thermoelectric module, the thermoelectric module being in thermal contact with the single chamber.

23. The method of claim 22, wherein said warming the baby bottle includes providing a DC voltage in a second direction, opposite the first direction to the thermoelectric module.

24. The method of claim 21 further comprising setting a first time on a clock, the clock being an integral component of the device for chilling and warming a baby bottle, the clock being adapted to begin performing said warming the baby bottle without removing the baby bottle from the single chamber at a second time based on the first time.

25. The method of claim 24, wherein the first and second times are the same.

26. The method of claim 24 further comprising (i) entering the volume of fluid contained in the baby bottle into the device for chilling and warming a baby bottle, (ii) calculating the second time based on the first time, the first time indicating a target time for the baby bottle to be sufficiently warmed and the first time being a start time for said warming the baby bottle without removing the baby bottle from the single chamber.
